(19) United States
(12) Patent Application Publication
(10) Pub. No.: US 2026/0330360 A1
(43) Pub. Date: Oct. 22, 2026

(54) SYSTEMS AND METHODS FOR POPULATING ACTIVITIES IN A WORKFLOW

(71) Applicant: ServiceNow, Inc., Santa Clara, CA (US)

(72) Inventors: Jan Ove Kristian Olsson, Castro Valley, CA (US); Reema Shah, San Diego, CA (US); Yaron Guez, San Diego, CA (US); Jennifer Lyons, San Diego, CA (US); Justin Scott Rubin, San Diego, CA (US); Karin Alexandra Chia Hwie Goh, San Francisco, CA (US)

(21) Appl. No.: 19/181,656

(22) Filed: Apr. 17, 2025

(51) Int. Cl. G06Q 10/0631; G06F 9/451

(52) U.S. Cl. CPC G06Q 10/06316; G06F 9/451; G06Q 10/06332; G06Q 10/0633

(57) ABSTRACT

A method includes receiving a natural language request to generate a workflow, wherein the natural language request specifies a characteristic of the workflow, generating, using a large language model (LLM), a skeleton workflow based on the characteristic, wherein the skeleton workflow comprises first and second placeholder activities, identifying, via retrieval augmented generation (RAG), a plurality of candidate activities, from a library of activities, to replace the first placeholder activity, identifying, using the LLM, a particular activity from the plurality of candidate activities to replace the first placeholder activity, and outputting the workflow, based on the skeleton workflow, that includes the particular activity in place of the first placeholder activity.

### TECHNICAL FIELD

The present disclosure relates generally to designing workflows, and more specifically to reducing resources utilized in designing workflows.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Generating and modifying workflows for processes can be tedious and time consuming. Workflow generation tools are used to generate workflows from scratch. The workflow generation tool typically builds a workflow activity-by-activity. For each activity in the workflow, the workflow generation tool specifies, or receives inputs specifying, the properties of the activity, such as inputs, outputs, actions that take place to generate the outputs based on the inputs, a label, a description, rules to apply during performance of the activity, triggers that initiate the activity, advanced properties of the activity, and so forth. Even in low-code or no-code environments, building workflows using a series of graphical objects interacted with via a graphical user interface (GUI) and having characteristics selected from groups of available options (e.g., via drop-down menus), is a time-consuming process. Techniques for making the creation of workflows faster, more efficient, and a better experience for workflow designers are needed. Faster and more efficient workflow generation is associated with lower processor utilization and reduces computational costs.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving a natural language request to generate a workflow, wherein the natural language request specifies a characteristic of the workflow, generating, using a large language model (LLM), a skeleton workflow based on the characteristic, wherein the skeleton workflow comprises first and second placeholder activities, identifying, via retrieval augmented generation (RAG), a plurality of candidate activities, from a library of activities, to replace the first placeholder activity, identifying, using the LLM, a particular activity from the plurality of candidate activities to replace the first placeholder activity, and outputting the workflow, based on the skeleton workflow, that includes the particular activity in place of the first placeholder activity.

In another embodiment, a system includes processing circuitry and a memory. The memory is accessible by the processing circuitry, and stores instructions that, when executed by the processing circuitry, cause the processing circuitry to receive a natural language request to generate a workflow, wherein the natural language request specifies a characteristic of the workflow, generate, using a large language model (LLM), a skeleton workflow based on the characteristic, wherein the skeleton workflow comprises first and second placeholder activities, identify, via retrieval augmented generation (RAG), a plurality of candidate activities, from a library of activities, to replace the first placeholder activity, identify, using the LLM, a particular activity from the plurality of candidate activities to replace the first placeholder activity, and output the workflow, based on the skeleton workflow, that includes the particular activity in place of the first placeholder activity.

In a further embodiment, a non-transitory, computer readable medium comprising instructions that, when executed by processing circuitry, cause the processing circuitry to receive a natural language request to generate a workflow, wherein the natural language request specifies a characteristic of the workflow, generate, using a large language model (LLM), a skeleton workflow based on the characteristic, wherein the skeleton workflow comprises first and second placeholder activities, identify, via retrieval augmented generation (RAG), a plurality of candidate activities, from a library of activities, to replace the first placeholder activity, identify, using the LLM, a particular activity from the plurality of candidate activities to replace the first placeholder activity, and output the workflow, based on the skeleton workflow, that includes the particular activity in place of the first placeholder activity.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance that hosts a workflow generation tool, in accordance with aspects of the present disclosure;

FIG. 5 is a screenshot of a GUI for submitting a request for a new workflow or playbook, in accordance with aspects of the present disclosure;

FIG. 6 is a screenshot of the GUI of FIG. 5 that includes a playbook preview window, in accordance with aspects of the present disclosure;

FIG. 7 is a screenshot of the GUI of FIG. 6, in which a preview of the playbook is displayed in the playbook preview window, in accordance with aspects of the present disclosure;

FIG. 8 illustrates a screenshot of the GUI of FIG. 7 in which an activity properties window is displayed in the playbook preview window in response to an activity being selected, in accordance with aspects of the present disclosure;

FIG. 9 illustrates a screenshot of the GUI of FIG. 8 in which a replace activity window is displayed in a designer window following selection of a placeholder activity, in accordance with aspects of the present disclosure;

FIG. 10 illustrates a screenshot of the GUI of FIG. 9 in which an activity properties window is displayed following selection of an activity in the workflow, in accordance with aspects of the present disclosure;

FIG. 11 illustrates a flow chart of a process for generating the playbook and/or workflow requested in FIG. 5, in accordance with aspects of the present disclosure;

FIG. 12 illustrates a schematic of a server generating the playbook and/or workflow requested in FIG. 5 based on inputs received from a client device running a native application, in accordance with aspects of the present disclosure;

FIG. 13 illustrates a schematic of the client device interfacing with the server for generating the playbook and/or workflow via an application programming interface (API), in accordance with aspects of the present disclosure; and

FIG. 14 illustrates a flow chart of a process for generating the playbook and/or workflow, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

Generating and modifying workflows for processes can be tedious and time consuming. Workflow generation tools are used to generate workflows from scratch. The workflow generation tool typically builds a workflow activity-by-activity. For each activity in the workflow, the workflow generation tool specifies, or receives inputs specifying, the properties of the activity, such as inputs, outputs, actions that take place to generate the outputs based on the inputs, a label, a description, rules to apply during performance of the activity, triggers that initiate the activity, advanced properties of the activity, and so forth. Even in low-code or no-code environments, building workflows using a series of graphical objects interacted with via a graphical user interface (GUI) and having characteristics selected from groups of available options (e.g., via drop-down menus), is a time-consuming process. Techniques for making the creation of workflows faster, more efficient, and a better experience for workflow designers are needed. Faster and more efficient workflow generation is associated with lower processor utilization and reduces computational costs.

Various embodiments disclosed herein are directed to a workflow generation tool that builds workflows, and in some cases entire playbooks (e.g., complete workflows along with GUIs presented as the workflow is performed), based on natural language inputs provided via the workflow generation tool, using a large language model (LLM). Specifically, a natural language input identifying one or more characteristics of a workflow to be generated may be provided via the workflow generation tool. The workflow generation tool utilizes an LLM to generate a skeleton workflow, including multiple placeholder activities. The LLM may reference existing workflows (e.g., used by the instance that hosts the workflow generation tool, within the enterprise, across an industry, across multiple industries, etc.), business process model and notation (BPMN) conventions, industry standard operating procedures, industry best practices, publicly available information, publications, data from the Internet, and so forth. The LLM builds the skeleton workflow placeholder activity by placeholder activity.

The workflow generation tool then populates the skeleton workflow by replacing the placeholder activities with fully defined activities from a library of activities (e.g., activities used by the instance that hosts the workflow generation tool, activities used by the enterprise, etc.). Specifically, the workflow generation tool uses retrieval augmented generation (RAG), or other artificial intelligence (AI)-based search techniques, and filtering to identify a group of candidate activities from the library of available activities to replace each placeholder activity. The workflow generation tool provides a prompt to the LLM identifying the group of candidate activities and requesting that the LLM select a particular activity from the candidate activities. The workflow generation tool receives, from the LLM, an identification of the particular activity and replaces the placeholder activity with the particular activity. The workflow generation tool repeats the population process for each placeholder activity in the skeleton workflow. In some cases, if the workflow generation tool cannot identify an activity to replace a placeholder activity, the workflow generation tool may keep the placeholder activity in the workflow to be defined later (e.g., based on inputs received from a client device in a workflow editing mode).

In some embodiments, the workflow generation tool may also be configured to populate a trigger of the workflow (e.g., the event or condition that initiates performance of the workflow). As with populating activities, the workflow generation tool may use RAG, or other AI-based search techniques, and filtering to identify a group of candidate triggers for the workflow. The workflow generation tool provides a prompt to the LLM identifying the group of candidate triggers and requests that the LLM select a trigger from the candidate triggers. The workflow generation tool receives, from the LLM, an identification of the selected trigger and adds the trigger to the workflow. The workflow generation tool may populate the trigger for a workflow prior to populating the activities, after populating the activities, or in parallel with populating the activities.

As the workflow generation tool populates the activities and/or trigger for a workflow, the workflow generation tool maintains a track generation context record, which may be a JavaScript Object Notation (JSON) record that tracks what steps have been performed in generating the workflow and the current status of the workflow generation. The workflow generation tool may reference the track generation context record to determine, for example, what steps have been performed so far in the workflow generation, what steps are next in the workflow generation, and so forth. Further, the workflow generation tool may be configured to generate a graphical user interface (GUI) that may be displayed on the client device during workflow generation. Accordingly, the workflow generation tool may reference the track generation context record and update the GUI to reflect the progress/status of the workflow generation. The workflow generation tool may also be accessible via API, allowing users to develop their own custom workflow generation GUIs that provide inputs to, and retrieve data from, the workflow generation tool via the API and update based on the retrieved data.

Use of the disclosed techniques may result in lower processor utilization and reduced computational costs associated with less time spent designing workflows. Further, deployment of the presently disclosed techniques may reduce problems with workflows resulting from human error.

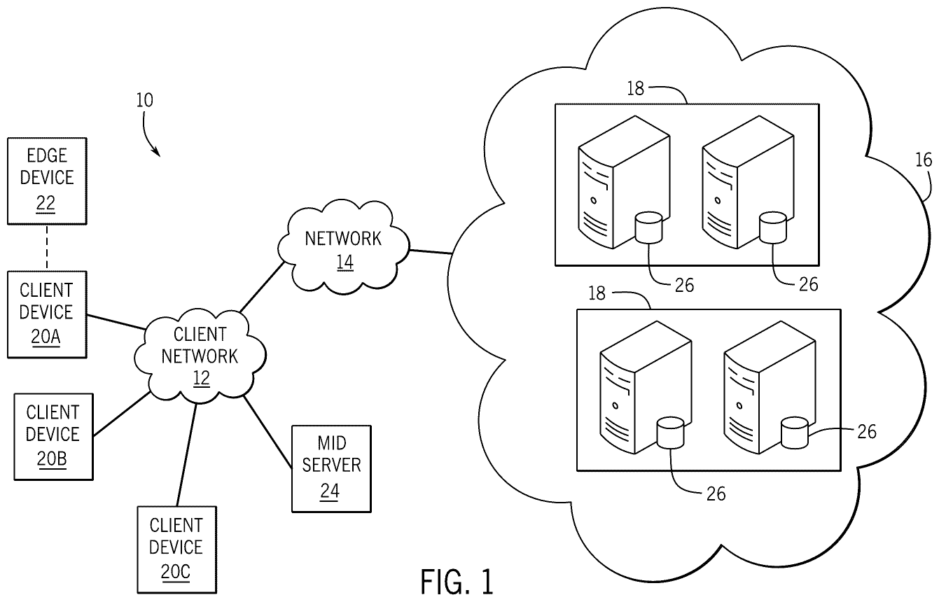

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial application, device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

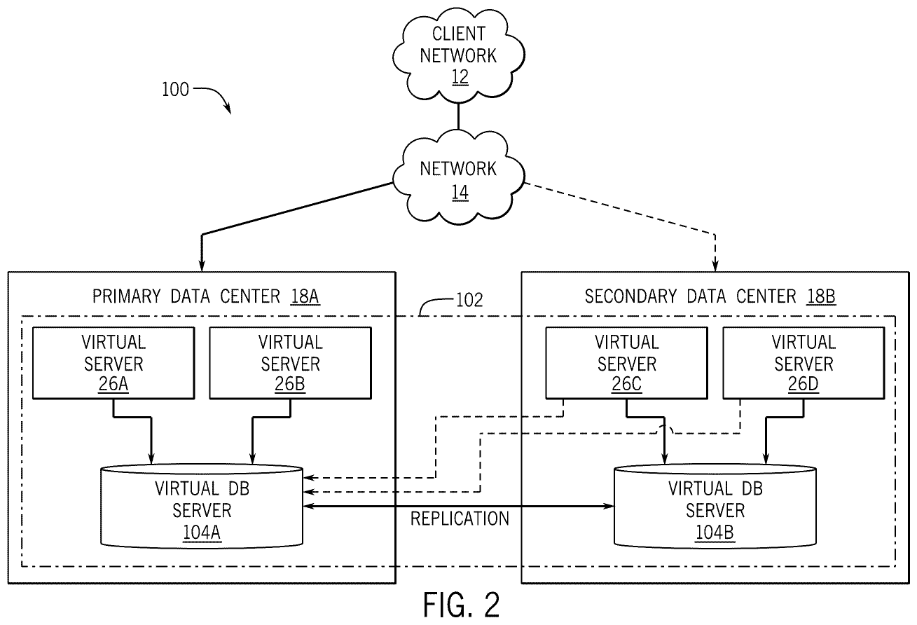

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

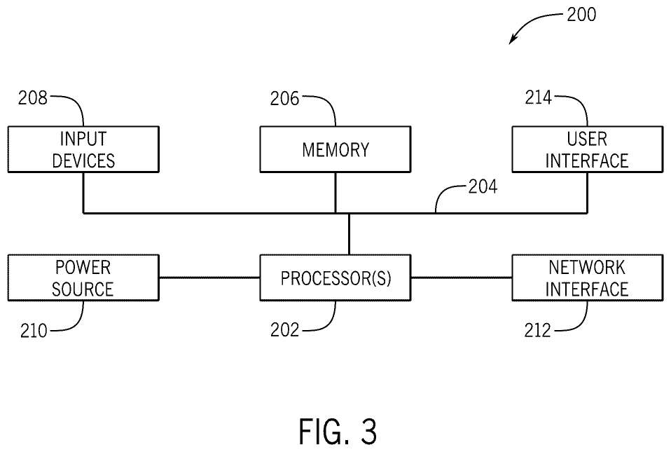

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

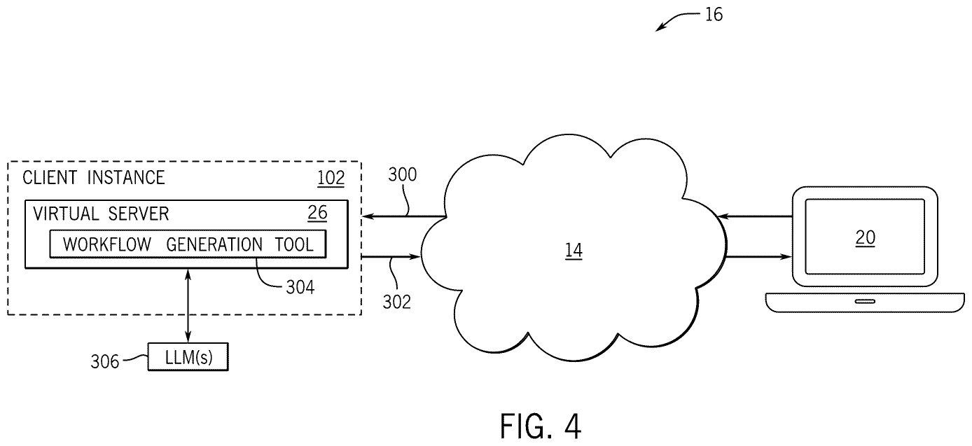

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 300, to which the client instance 102 may respond with outputs 302. In the embodiment shown in shown in FIG. 4, the virtual server 26 of the client instance 120 may run a workflow generation tool 304, which may be a software application defined by code, accessible via a native application or web browser of the client device 20, either directly or via an API. Accordingly, the inputs 300 may include inputs requesting a workflow, specifying one or more characteristics of a workflow, providing feedback on a generated workflow, requesting modifications to a workflow, and so forth. Correspondingly, the outputs 302 may include requested workflows (e.g., skeleton workflows, partially complete workflows, complete workflows, etc.), responses to inputs 300, questions, and so forth. The workflow generation tool 304 may utilize one or more large language models 306 (LLMs), which may be accessible to the client instance 102 (as shown in FIG. 4), or stored within the client instance 102, to generate some or all of the outputs 302. As used herein, a large language model (LLMs) is a probabilistic model of a natural language used for general-purpose language generation. LLMs typically include one or more artificial neural networks having a transformer-base architecture. LLMs learn statistical relationships from text documents through training processes that may be supervised, semi-supervised, or self-supervised. During training, LLMs may learn syntax, semantics, and/or ontology. LLMs, when used for text generation, receive an input text and iteratively predict the next word or token. It should be understood that the client instance 102 shown in FIG. 4 may be utilized by the client device 20 for other tasks associated with workflows, as well as tasks beyond the scope of workflow generation and modification.

Traditionally, generating and modifying workflows for processes using workflow generation tools has been tedious and time consuming. For example, workflows were typically built from scratch, using workflow generation tools to define: activities performed during the workflow; stages (e.g., groupings) of activities within the workflow; how some activities within the workflow may be dependent on outputs from other activities in the workflow or from external data sources; the order of activities within the workflow; whether activities can be performed in parallel; and so forth. Accordingly, workflows tend to be built activity-by-activity, using the workflow generation tools to specify, for each activity in the workflow, the properties of the activity, such as inputs, outputs, actions that take place to generate the outputs based on the inputs, a label, a description, rules to apply during performance of the activity, triggers that initiate the activity, advanced properties of the activity, and so forth. Even in low-code or no-code environments, building workflows using a series of graphical user interfaces (GUIs) with characteristics selected from groups of available options (e.g., drop-down menus), is a time-consuming process prone to human error. Even in instances in which the LLM 306 is used to generate a skeleton workflow populated with placeholder activities, the placeholder activities are manually replaced with fully defined activities. Further, once the workflow has been created, the workflow generation tool, or a GUI design tool, generates the GUIs presented as the workflow is performed. Techniques for making the creation of workflows faster, more efficient, and a better experience for workflow designers are needed. Faster and more efficient workflow generation is associated with lower processor utilization and reduces computational costs.

The presently disclosed workflow generation tool 304 receives natural language inputs and uses the LLMs 306 to automatically build workflows based on the inputs, and in some cases entire playbooks (e.g., complete workflows along with GUIs presented as the workflow is performed). As used herein, “natural language” is intended as language, either written, typed, or spoken by a human being. Accordingly, a natural language input may be one or more human-readable alphanumeric character strings, or audio, the meaning of which may be understood by a human. As shown in FIG. 4, the workflow generation tool 304 may receive a natural language input 300 from the client device, such as “I would like to create a product development playbook.” The workflow generation tool 304 utilizes the one or more LLMs 306 to generate a skeleton workflow, including multiple placeholder activities, which may or may not be grouped into stages. The workflow generation tool 304 subsequently “hydrates” or populates the workflow by automatically replacing the placeholder activities with fully defined activities and identifying a trigger for the workflow (e.g., an action or condition that initiates the workflow). The workflow generation tool 304 outputs the populated workflow, or a complete playbook, as an output 302.

As used herein, a workflow is a sequence of activities or steps that combine to form a process performed in the operation of an enterprise or organization. Correspondingly, a skeleton workflow is a workflow made up of multiple activities wherein at least one of the multiple activities has undefined or unspecified properties or parameters. The one or more LLMs 306 may be trained, for example, on existing workflows (e.g., within the enterprise, across an industry, across multiple industries, etc.), business process model and notation (BPMN) conventions, industry standard operating procedures, industry best practices, publicly available information, publications, data from the Internet, and so forth. In some embodiments, the one or more LLMs 306 may be “off the shelf” or “out of the box” LLMs 306 provided by a service provider and not unique to the client instance 102. However, in other embodiments, the LLMs may be customized to the client instance 102, either with specific training (such as training specific to a client's business, procedures, technology, products or services, and so forth), specific customized settings, or both.

As is described in more detail below, the workflow generation tool 304 may use the one or more LLMs 306 to build the skeleton workflow placeholder-activity-by-placeholder-activity. Each placeholder activity may include proposed placeholder values for one or more properties of the corresponding placeholder activity. For example, a placeholder activity of the skeleton workflow may include proposed placeholder values for inputs, outputs, actions that take place to generate the outputs based on the inputs, a label, a description, rules to apply during performance of the activity, triggers that initiate the activity, advanced properties of the activity, or some combination thereof.

The workflow generation tool 304 populates the skeleton workflow with fully defined activities by using retrieval augmented generation (RAG) and/or AI-based search to identify candidate activities from a library or table of available activities (e.g., activities used by the instance 102) to replace each of the placeholder activities. RAG is an AI-based technique that enhances the capabilities of the workflow generation tool 304 by allowing it to access and reference knowledge bases, such as the enterprise's internal documents or a specific database, ensuring search results are tailored to the specific context by accessing up-to-date information not included in the LLM's initial training data. For each placeholder activity, the workflow generation tool 304 provides a prompt to the LLM 306 that identifies the candidate activities and requests that the LLM select a particular activity from the candidate activities. The workflow generation tool 304 receives, from the LLM 306, identification of a particular activity of the candidate activities and the workflow generation tool 304 replaces the placeholder activity with the particular activity. The workflow generation tool 304 repeats the population process for each placeholder activity in the skeleton workflow. In some cases, if the workflow generation tool 304 cannot identify an activity to replace a placeholder activity, or the LLM 306 determines that none of the candidate activities are good replacements for the placeholder activity, the workflow generation tool may keep the placeholder activity in the workflow to be defined later (e.g., based on inputs received from a client device in a workflow editing mode).

In some embodiments, the workflow generation tool 304 may also be configured to populate a trigger of the workflow (e.g., the event or condition that initiates performance of the workflow). In such embodiments, the workflow generation tool 304 may use AI-based search techniques, such as RAG, to identify a group of candidate triggers for the workflow. In some embodiments, if the number of candidate triggers is larger (e.g., greater than some threshold number), the workflow generation tool 304 may use filtering to reduce the number of candidate triggers to a more manageable number of candidate triggers. To select a trigger from the candidate triggers, the workflow generation tool 304 provides a prompt to the LLM 306 identifying the group of candidate triggers and requesting that the LLM 306 select a trigger from the candidate triggers. The prompt may also include contextual information about the workflow to help the LLM 306 select the trigger. The workflow generation tool 304 receives, from the LLM 306, an identification of the selected trigger and adds the trigger to the workflow. The workflow generation tool 304 may populate the trigger for a workflow prior to populating the activities, after populating the activities, or in parallel with populating the activities.

As the workflow generation tool 304 populates a workflow, the workflow generation tool 304 maintains a track generation context record (e.g., a JSON record that tracks what steps have been performed in generating the workflow, the current status of the workflow generation, and what steps are next in the workflow generation). The workflow generation tool 304 may be configured to reference the track generation context record to determine what steps have been performed so far in the workflow generation, what steps are next in the workflow generation, and so forth. In some embodiments, the workflow generation tool 304 also generates one or more graphical user interfaces (GUIs) that may be displayed on the client device during the workflow generation. Accordingly, the workflow generation tool may reference the track generation context record and update the GUI to reflect the progress/status of the workflow generation. In some embodiments, the workflow generation tool 304 may be accessible via API, allowing users to develop their own custom workflow generation GUIs that provide inputs to, and retrieve data from, the workflow generation tool 304 via the API and update based on the retrieved data.

The track generation context record and/or the workflow generated by the workflow generation tool 304 may be transmitted to the client device 20 as an output 302 for display via the client device 20 by way of a native application (e.g., a corresponding client-side version of the workflow generation tool 304) or a web browser. The client device 20 may receive inputs requesting modifications to or making edits to the workflow, and/or providing feedback to the workflow generation tool. The edits/modifications may be made to a local copy of the skeleton workflow stored on the client device 20, or transmitted by the client device 20 to the client instance 102 as inputs 300 for modification of a copy of the workflow stored by the client instance 102.

For example, the inputs may provide replacement values for one or more properties of activities, add new activities, remove activities, replace placeholder activities with activities selected from an activity library or new activities, and so forth. Further, in some embodiments, the workflow generation tool 304 may present, via the client device 20, suggestions for replacing placeholder activities with activities from a library when a placeholder activity is selected. In further embodiments, the workflow generation tool 304 may include a chat interface by which feedback on the skeleton workflow may be provided in natural language and the workflow generation tool 304 uses the one or more LLMs 306 to make changes to the workflow based on the feedback provided.

In some embodiments, the workflow generation tool 304 may be configured to generate a complete playbook, which includes a complete workflow, as opposed to a skeleton workflow, along with one or more GUIs to be displayed by a client device 20 as the workflow is performed. As used herein, a complete workflow is a workflow having multiple activities, wherein all of the activities in the workflow have fully defined properties. Accordingly, none of the activities in a complete workflow have undefined parameters. In such embodiments, changes to the complete workflow may be received (e.g., add/remove activities, specify different values for activity properties, etc.), and/or feedback on the playbook received via a chat interface or the workflow generation tool, which may cause the workflow generation tool to make changes to the playbook based on the feedback received via the workflow generation tool.

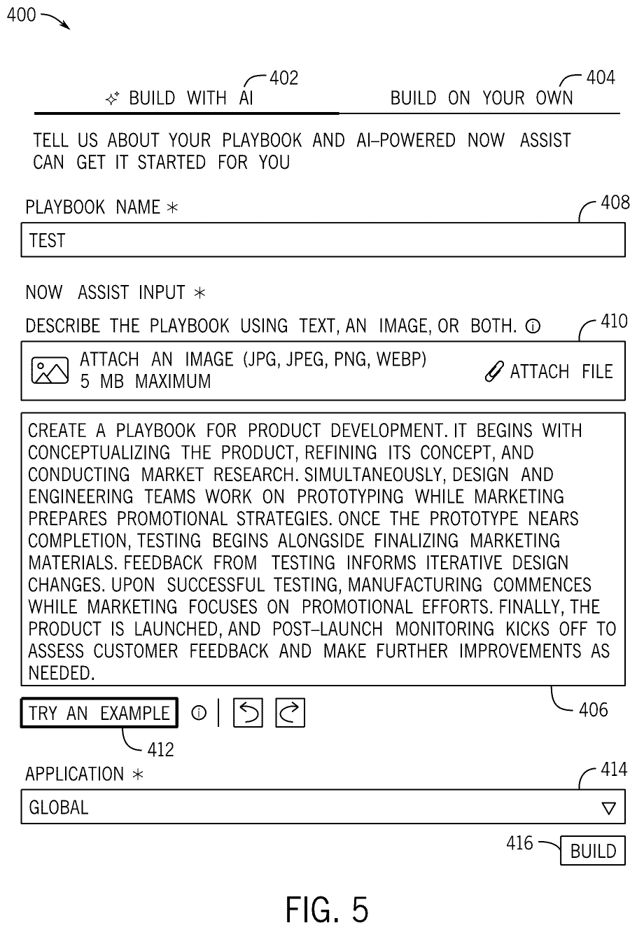

With the foregoing in mind, FIGS. 5-10 represent example screenshots of GUIs that may be displayed via the client device during creation of a new workflow and/or modification of an existing workflow. It should be understood, however, that the screenshots depicted in FIGS. 5-10 are merely examples and that embodiments having different GUIs are envisaged. Specifically, FIG. 5 is a screenshot of a GUI 400 for submitting a request for a new workflow or playbook. As illustrated, the GUI 400 for submitting a request for a new workflow includes first tab 402 and a second tab 404. The first tab 402, when selected, uses artificial intelligence (e.g., an LLM-based generative artificial intelligence workflow generation tool) to generate the new workflow. The second tab 404, when selected, allows a workflow to be built manually from scratch. Though the present disclosure is mostly directed to using the LLM-based generative AI capabilities of the workflow generation tool, it should be understood that the workflow generation tool may also be used to build workflows from scratch.

When the first tab 402 is selected (e.g., the LLM-based generative AI workflow generation tool is being used), the GUI includes a prompt window 406 in which a prompt (e.g., an input describing one or more characteristics of the workflow to be created) is provided. As shown, a prompt is shown in the prompt window 406 (e.g., “Create a playbook for product development . . . ”). In some embodiments, the GUI 400 may also include a name field 408 for the workflow or playbook, and/or an attachment field 410 for attaching a file (e.g., jpg, jpeg, png, webp, etc.) to be used in generating of the workflow. In some embodiments, the GUI 400 may also include a link to an example demo 412, that, when selected, provides an example demonstration for how to use the LLM-based generative AI workflow generation tool. An application scope field 414 may be used to define a scope of the application (e.g., global or scoped). Once a prompt has been provided in the prompt window 406, the build button 416 may be selected to provide the prompt as an input to the LLM-based generative AI workflow generation tool to generate a workflow based on the prompt. In the instant embodiment, as is discussed below regarding the subsequent figures, the submitted prompt was a request to create a playbook for product development, however, it should be understood that this is merely an example and that embodiments are envisaged in which the LLM-based generative AI workflow generation tool generates workflows for processes beyond product development.

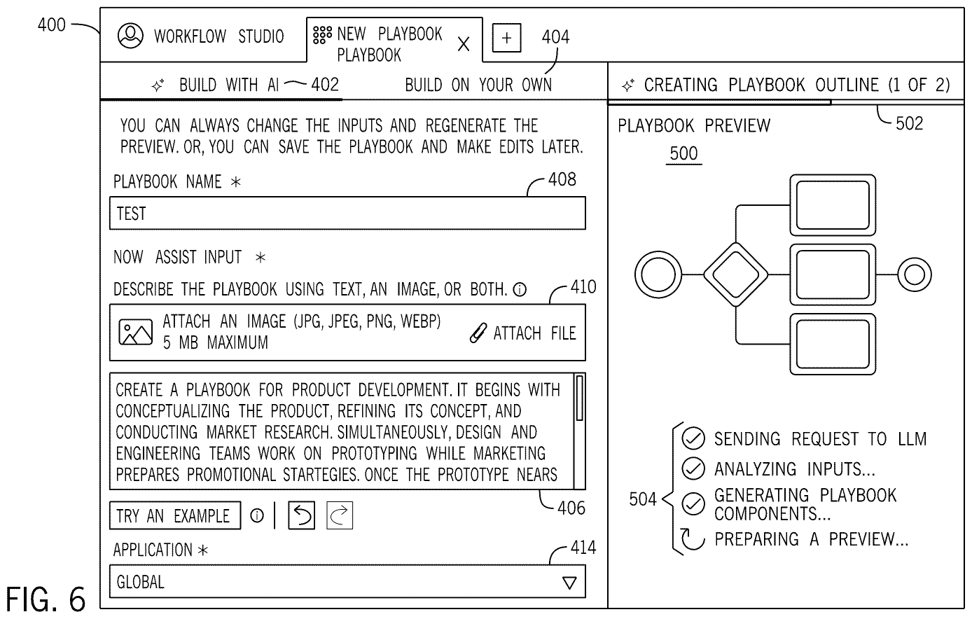

Once the build button 416 has been selected, the GUI 400 updates to include a playbook preview window. FIG. 6 is a screenshot of the GUI 400 of FIG. 5 for submitting a request for a new workflow or playbook that includes a playbook preview window 500. When the build button 416 is selected, the text in the prompt window 406 and the attached files provided via the attachment field 410, if any, are provided to the workflow generation tool, which provides the prompt and the attached files, either as-received or with some processing, to the LLM, to generate a skeleton workflow based on the prompt and the attached files. The skeleton workflow is made up of placeholder activities. Each placeholder activity may include proposed placeholder values for one or more properties of the corresponding placeholder activity. For example, placeholder activities may include proposed placeholder values for inputs, outputs, actions that take place to generate the outputs based on the inputs, a label, a description, rules to apply during performance of the activity, triggers that initiate the activity, advanced properties of the activity, or any combination thereof.

The LLMs may be trained on existing workflows (e.g., within the enterprise, across an industry, across multiple industries, etc.), business process model and notation (BPMN) conventions, industry standard operating procedures, industry best practices, publicly available information, publications, data from the Internet, and so forth. In some embodiments, the one or more LLMs may be “off the shelf” or “out of the box” LLMs provided by a service provider and not unique to the client instance. However, in other embodiments, the LLMs may be customized to the client instance, either with specific training, specific customized settings, or both.

The workflow generation tool populates the skeleton workflow by replacing one or more of the placeholder activities with fully defined activities from a library of activities (e.g., activities used by the instance that hosts the workflow generation tool, activities stored in a table on the instance, activities used by the enterprise, and so forth). The workflow generation tool uses AI-based search techniques, such as RAG, to identify candidate activities to replace the placeholder activities. In some embodiments, the workflow generation tool may also utilize a filtering algorithm to reduce the number of candidate activities. The workflow generation tool provides a prompt to the LLM requesting that the LLM select a particular activity from the candidate activities to replace a respective placeholder activity. The workflow generation tool receives an output from the LLM identifying the particular activity and replaces the placeholder activity in the workflow with the particular activity. The workflow generation tool sends the LLM another prompt requesting the LLM select a replacement activity for a subsequent placeholder activity and proceeds through the placeholder activities in order, in batches, and/or according to some sequence. In some embodiments, the workflow generation tool may not identify any candidate activities to replace a placeholder activity, and/or the LLM may determine that none of the candidate activities are suitable replacements for a placeholder activity. In such embodiments, the workflow generation tool leaves the placeholder activity in the workflow (e.g., to be defined by a user in an editing mode).

As the workflow generation tool works its way through generating the skeleton workflow and populating the skeleton workflow, replacing placeholder activities with fully defined activities, the workflow generation tool may generate and subsequently maintain a track generation context record (e.g., a JSON record) that indicates the workflow generation tool's progress in generating the workflow. For example, the track generation context record may track what steps have been performed in generating the workflow and/or the current status of the workflow generation. The workflow generation tool may reference the track generation context record to determine, for example, what steps have been performed so far in the workflow generation, what steps are next in the workflow generation, and so forth. The track generation context record may also be used to generate and/or update the GUI 400 shown in FIG. 6, which may be displayed on the client device. The GUI 400 may be generated and displayed by the client device, or generated by the instance and transmitted to the client device for display. For example, the workflow generation tool may reference the track generation context record and update the GUI 400 to reflect the progress and/or status of the workflow generation.

As shown in FIG. 6, the GUI 400 may be updated to include a playbook preview window 500 configured to display a preview of the playbook and/or workflow and a status bar 502 that indicates the progress in generating the workflow/playbook. If a preview of the playbook/workflow is not yet ready for display, the playbook preview window 500 may update to show a list of steps 504 the workflow generation tool takes in generating the playbook/workflow preview, what steps have been completed, what steps are in process, and what steps are yet to be performed.

Specifically, the workflow generation tool uses the LLM to generate a skeleton workflow, which is populated with placeholder activities. The workflow generation tool then populates the skeleton workflow with fully defined activities by using retrieval augmented generation (RAG), or other artificial intelligence (AI)-based search techniques to identify one or more candidate activities for each placeholder activity in a workflow, and provides a prompt to an LLM requesting that the LLM select an activity from the candidate activities to replace the placeholder activity, or leave the placeholder activity in place. The workflow generation tool receives an output from the LLM and either replaces the placeholder activity with a selected fully-defined activity, or leaves the placeholder activity in place.

As the workflow generation tool is generating the workflow, the workflow generation tool generates and maintains a track generation context record indicative of what steps have been performed in generating the workflow and the current status of the workflow generation. The GUI 400 of FIG. 6 may be updated based on the track generation context record to indicate the progress made by the workflow generation tool in generating the workflow and/or playbook.

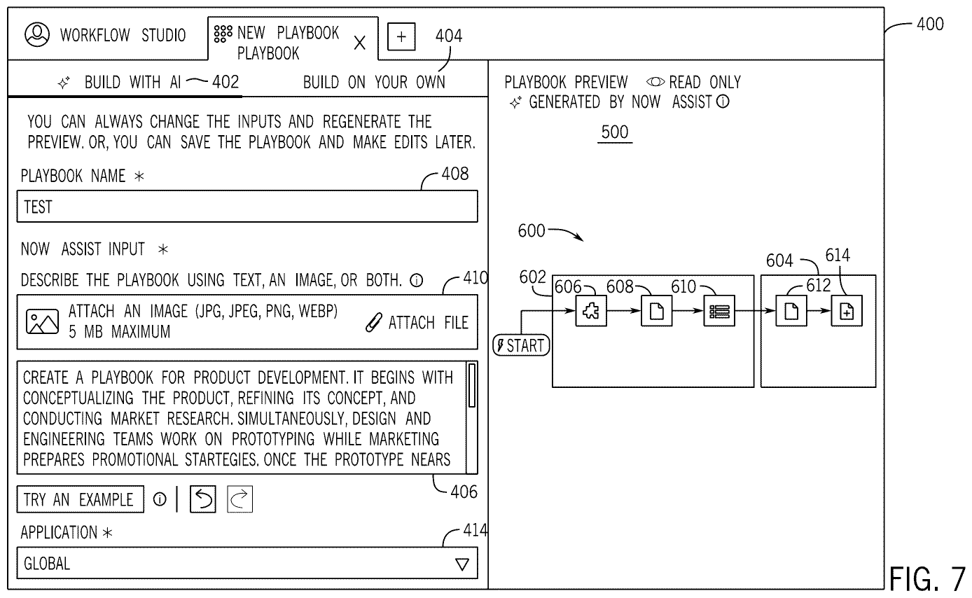

FIG. 7 is a screenshot of the GUI 400 of FIG. 6 in which a preview of the playbook 600 is displayed in the playbook preview window 500. As shown, each activity is represented by a box, with arrows connecting the boxes to indicate the order in which the activities are performed. It should be understood, however, that the playbook shown in FIG. 7 is merely an example and that the disclosed techniques may be applied to different playbooks. In some embodiments, activities may be grouped into stages, which may be represented by shaded boxes in which the activity boxes are disposed. For example, the portion of the playbook 600 for product development shown FIG. 7 includes a conceptualization and research stage 602 and a design and prototyping stage 604. As shown, the conceptualization and research stage 602 includes a “conceptualize product” placeholder activity 606 (as evidenced by the plain tile with a puzzle piece), as well as a fully defined “refine product concept” activity 608 and a “conduct market research” activity 610. The design and prototyping stage 604 includes a “design product” activity 612 and a “create prototype” activity 614. As indicated by the arrow extending form the design and prototyping stage 604, the playbook 600 includes additional activities not shown in the playbook preview window 500.

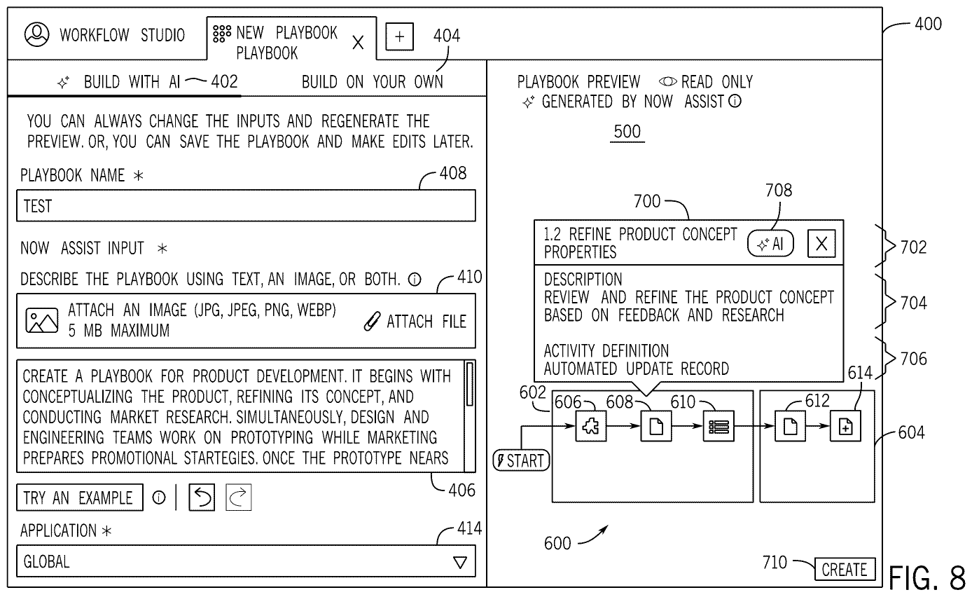

FIG. 8 is a screenshot of the GUI 400 of FIG. 7 in which an activity properties window 700 is displayed in the playbook preview window 500 in response to an activity, in this case the refine product concept activity 608, being selected. As shown, the activity properties window 700 displays various properties of the selected activity, which can be viewed, modified, and/or further defined. For example, in the embodiment shown in FIG. 8, the activity properties window 700 includes an activity name 702 field, an activity description field 704, and an activity definition field 706. It should be understood, however, that in other embodiments, the activity properties window 700 may be configured to display additional fields, fewer fields, and/or different fields. As shown, in some embodiments, the activity properties window 700 may include an AI sticker 708 that appears for fields, or entire activities, that were generated using AI (e.g., via an LLM).

Though not shown in FIG. 8, in some embodiments, the workflow generation tool may be configured to populate a trigger for the workflow (e.g., the event or condition that initiates performance of the workflow). Similar to the process of populating activities, the workflow generation tool uses RAG and/or other AI-based search techniques to identify a group of candidate triggers for the workflow. If the group of candidate triggers exceeds some threshold value, the workflow generation tool may use filtering to reduce the group of candidate triggers to a number of candidate triggers below the threshold. The workflow generation tool then provides a prompt to the LLM that identifies the candidate triggers and asks the LLM to select a trigger from the candidate triggers. The workflow generation tool receives an identification of the selected trigger from the LLM and adds the trigger to the workflow. The workflow generation tool may populate the trigger for a workflow prior to populating the activities, after populating the activities, or in parallel with populating the activities. Upon selection of a create button 710, the playbook and/or workflow is generated.

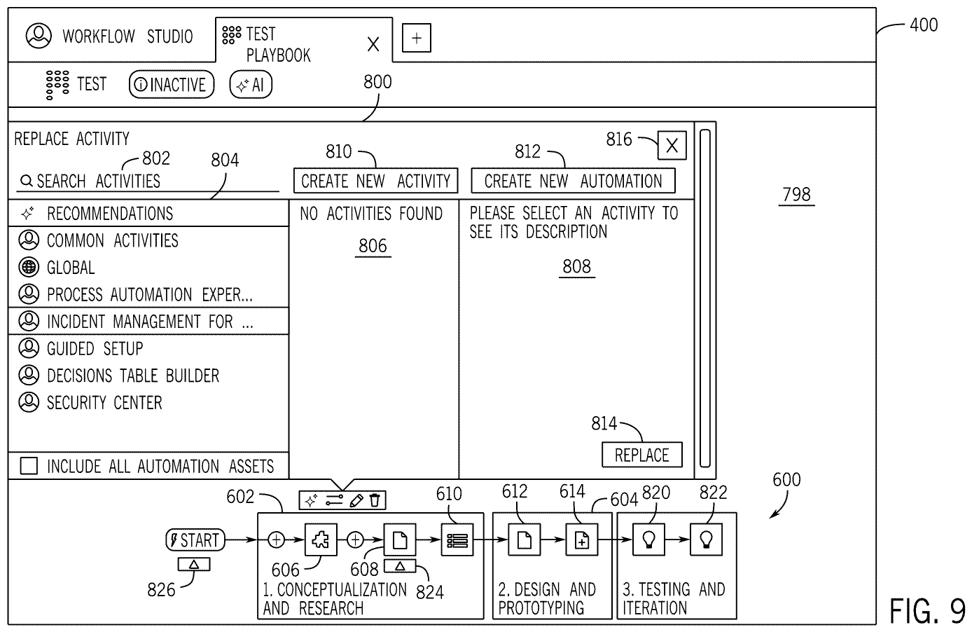

In order to edit and/or replace activities (e.g., replacing a placeholder activity with a fully-defined activity or defining undefined characteristics of placeholder activities), the workflow may be put into an editing mode and displayed in a designer window. In workflow editing mode, selecting a placeholder activity, such as the conceptualize product placeholder activity 606, may guide a user through replacing the placeholder activity with a fully defined activity. FIG. 9 is a screenshot of the GUI of FIG. 8 in which a replace activity window 800 is displayed in a designer window 798 following selection of the conceptualize product placeholder activity 606. In some embodiments, the replace activity window 800 may include a search activities field 802 configured to receive inputs (e.g., alphanumeric text) that may be used as queries to search for particular activities to add to the workflow 600. When the search activities field 802 is used, results from the search may be displayed within the replace activity window 800. If the results include multiple activities, an input may be received selecting an activity from the list of results.

Alternatively, activities may be found by navigating through one or more menus. For example, an activity categories list 804 may list available activity categories. For example, in the instant embodiment, the available activity categories include AI-generated recommendations, common activities, global activities, process automation experience activities, incident management for services activities, guided setup activities, decision table builder activities, security center activities, and so forth. However, it should be understood that the activity categories shown in FIG. 9 are merely examples and that other activity categories may be available. Though no recommended activities are shown in FIG. 9, activities may be recommended (e.g., using an LLM trained on existing workflows, business data, BPMN, industry standard operating procedures, a curated set or library of activities, and so forth) based on one or more characteristics of the workflow, other similar workflows, historical data from the user profile generating the workflow, etc. In some embodiments, the recommended activities may be broken up into groups, such as interactive activities, non-interactive activities, subflows, RPA process, actions, etc. Recommended activities may be selected from the activities list 806 to replace placeholder activities in a workflow or otherwise be added to a workflow.

Upon receiving a selection of a particular activity category, the replace activity window 800 may display an activity list 806 that lists the activities that fall within the selected particular category. Upon selection of an activity from the activity list 806, an activity details window 808 may be configured to display more information about the selected activity. For example, if an instruction activity has been selected, so the activity details window 808 may display a description of the selected instruction activity (e.g., that the instruction activity provides an instruction to the process user, allowing for the process author to define a message to display). Further, the activity details window 808 may display other characteristics of the selected activity, such as inputs and/or outputs.

In some embodiments, the replace activity window 800 include selectable buttons for creating a new activity 810 and/or creating a new automation 812 that, when selected may cause the replace activity window 800 to guide a user through a series of steps for defining a new activity and/or automation. Once created, the new activity and/or automation may be selected to replace the placeholder activity.

Upon selection of the replace activity button 814, the placeholder activity is replaced with the selected fully defined activity the workflow 600. Once the placeholder activity has been replaced by the selected activity, the activity may be selected and properties of the activity may be displayed and/or modified in the activity properties window. Alternatively, to close the add activity window 600 without creating a new activity, a close window 816 button may be selected.

In addition to the replace activity window 800, FIG. 9 illustrates a few other features of the GUI 400 worth noting. First, the playbook preview window 500 has been expanded to show more of the playbook preview such that an additional stage, a testing and iteration stage 818, is shown that includes a test prototype activity 820 and an iterate design activity 822. Further, the playbook preview window 500 shows alert buttons 824 disposed between multiple activities 608, 614 in the workflow, as well as an alert icon 826 at the start of the workflow, indicating that the corresponding activities have alerts to be resolved. Accordingly, in response to the alert buttons 824 being selected, the GUI 400 may update to display an alert window to guide the user through resolving the alerts.

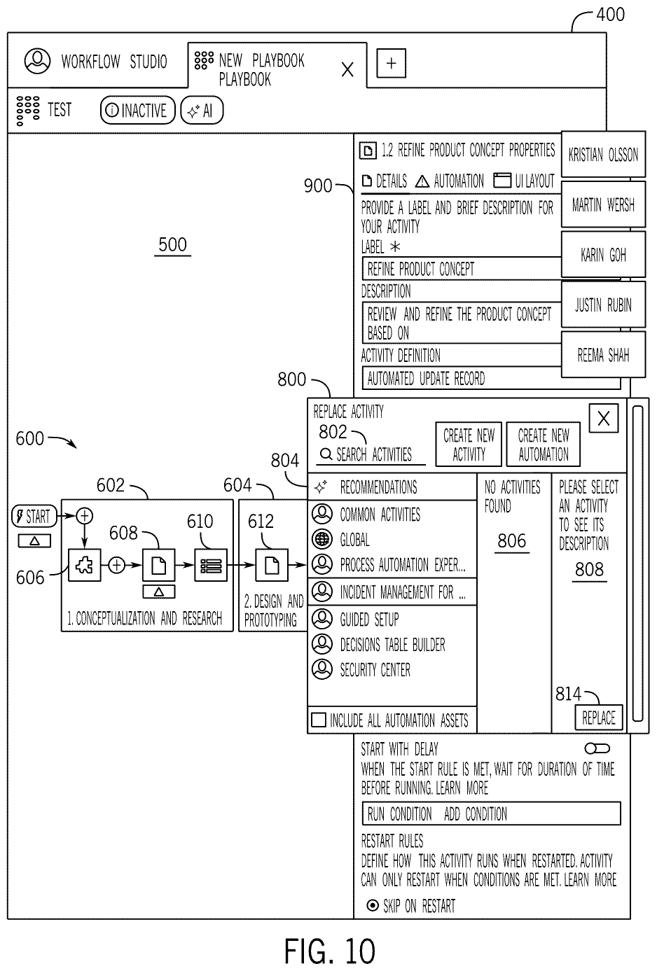

Once the workflow has been put into an editing mode, when an activity is selected, the GUI 400 may update to display various characteristics of the selected activity. For example, FIG. 10 is a screenshot of the GUI of FIG. 9 in which an activity properties window 900 is displayed following selection of an activity in the workflow. In the embodiment shown in FIG. 10, the refine product concept activity 608 has been selected. When an activity is selected, the activity properties window 900 displays editable properties of the corresponding activity that may or may not be displayed in the playbook preview window 500. The properties displayed in the activity properties window 900 may be modified by providing inputs to the GUI. For example, the activity properties window 900 displays properties related to, for example, a label field, a description field, an activity definition field, a define trigger condition field (e.g., when the stage starts, after a specific activity, etc.), an activity display order field, conditions that delay start of the activity, rules for restarting the activity, and so forth. By modifying characteristics of fully defined activities and/or further defining properties of placeholder activities, activities within the workflow may be fully defined or more defined than they were previously. However, it should be understood that the activity properties window 900 shown in FIG. 10 is merely an example and that embodiments are envisaged in which the activity properties window 900 includes different fields, has a different design, shows data in a different way, and so forth. Once any desired changes have been made, the workflow and/or playbook may be saved and/or implemented.

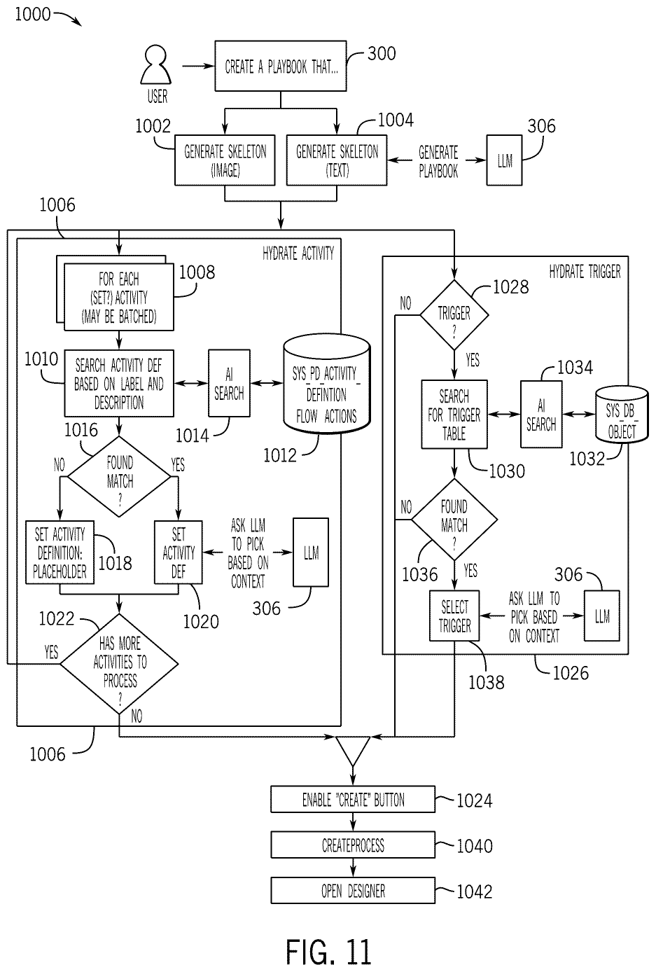

FIG. 11 is a flow chart of a process 1000 for generating a workflow. The process 1000 receives an input 300 requesting creation of a playbook or workflow. The process 1000 provides the input 300 to an LLM 306 in a prompt that asks the LLM 306 to generate a skeleton workflow (including a skeleton workflow image 1002 and skeleton workflow text 1004) based on the input 300.

After the skeleton workflow has been created, the process proceeds to a hydrate (e.g., expansion or completion) activity sub-process 1006. At 1008, the process 1000 may perform the hydrate activity sub-process 1006 for each activity in the skeleton workflow separately, for groups of activities in the skeleton workflow, or for all of the activities in the skeleton workflow at once. At 1010, the process 1000 searches available activity definitions (e.g., in an activity definitions database 1012 or table, activities used by the instance, etc.) based on the respective label and the description of a placeholder activity. As shown at 1014, the process 1000 may or may not utilize RAG or other AI-based search techniques. At decision 1016, the process 1000 determines whether or not a matching activity has been found. If no matching activity has been found, the process proceeds to 1018 and sets the activity definition to “placeholder”, leaving the placeholder activity in the workflow. If, at decision 1016, one or more matching activities have been found, the process proceeds to block 1020 and provides an input to the LLM 306 asking the LLM to pick from the matching activities. The process 1000 receives a selection from the LLM 306 and sets the activity definition for the corresponding activity to match the activity definition of the selected activity. At decision 1022, the process 1000 determines whether or not there are more placeholder activities to process. If so, the process 1000 repeats the hydrate activity sub-process 1006. If not, the process proceeds to enable the “create” button to create the workflow.

The process 1000 also performs a hydrate trigger sub-process 1026, which may be performed prior to performance of the hydrate activity sub-process 1006, at the same time as performance of the hydrate activity sub-process 1006 (e.g., in parallel), and/or after performance of the hydrate activity sub-process 1006. At decision 1028, the process 1000 determines whether the workflow and/or playbook is initiated by a trigger (e.g., the playbook and/or workflow has a trigger, such as a placeholder trigger, to hydrate). If not, the process 1000 determines that the playbook and/or workflow has no trigger to hydrate and proceeds to 1024. If, at decision 1028, the playbook and/or workflow has a trigger to hydrate, the process 1000 proceeds to 1030 and searches for a trigger table, or other source of triggers in a trigger definitions database 1032, or some other source of trigger information (e.g., triggers used by other playbooks and/or workflows on the instance, etc.). In some embodiments, the process 1000 may utilize RAG or other AI search techniques 1034 to identify one or more candidate triggers. If, at decision 1036, no matching triggers are found, the process 1000 ends the hydrate activity sub-process 1006 and proceeds to block 1024. If, at decision 1036, one or more matching triggers are found, the process 1000 proceeds to 1038 and selects a trigger from the one or more candidate triggers. In some embodiments, the process 1000 may provide a prompt to the LLM 306 that identifies the candidate triggers and asks the LLM 306 to select a trigger from the candidate triggers based on other known information about the playbook and/or workflow being generated. The process 1000 then defines the trigger of the playbook and/or workflow (e.g., by replacing the placeholder trigger) as the selected trigger.

The process 1000 proceeds to block 1024 and enables a “create” button to be displayed via a GUI (e.g., the create button 710 of FIG. 8). In response to the create button being selected, the process 1000 proceeds to block 1040 and creates the playbook and/or workflow using the activities selected during execution of the hydrate activity sub-process 1006 and the trigger, if any, selected during the hydrate trigger sub-process 1026. If, during the hydrate activity sub-process 1006, no fully defined activities were found to replace one or more placeholder activities, the playbook and/or workflow may be generated with the placeholder activities left intact (as shown in FIGS. 8-10). Creating the playbook and/or workflow may include running one or more scripts that generate pieces of code and/or write data to one or more tables that define various characteristics of the playbook and/or workflow, as well as various characteristics of the activities and/or triggers included in the playbook and/or workflow.

After the playbook and/or workflow has been created, the process 1000 may proceed to block 1042 and open a flow designer window that puts the playbook and/or workflow into an editing mode in which a use can provide inputs modifying characteristics of one or more activities, replacing placeholder activities with fully defined activities, replacing fully defined activities with other fully defined activities, and so forth, as shown in FIGS. 9 and 10.

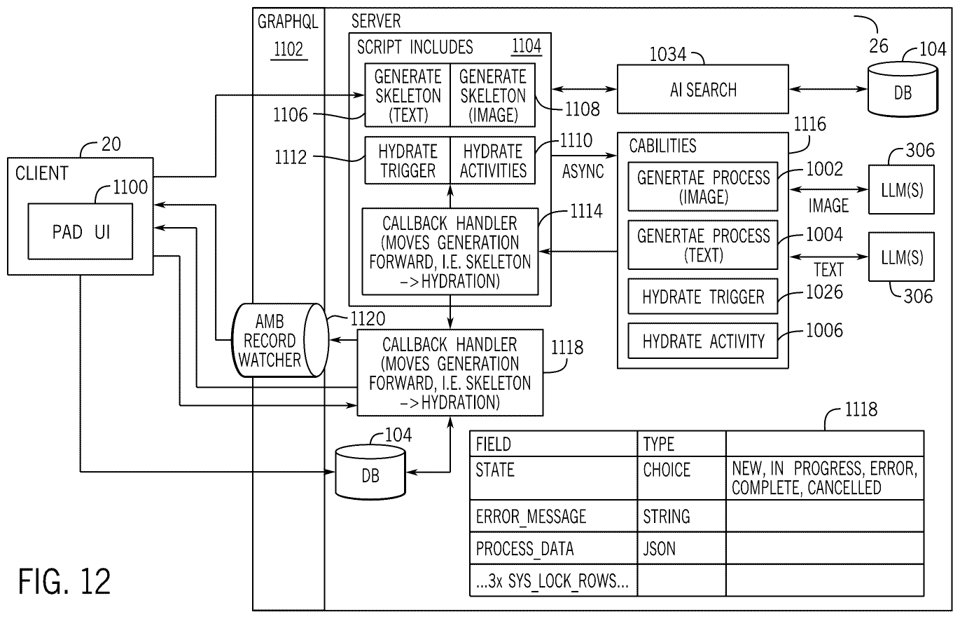

FIG. 12 illustrates a schematic of a server 26 generating a playbook and/or workflow based on inputs received from a client device 20 running a native application (e.g. having a PAD UI 1100). As previously described, the client device 20, via the PAD UI 1100, receives an input requesting generation of a playbook and/or workflow. The client device 20 provides a command to generate the playbook and/or workflow to the server 26. In some embodiments, the command may be passed from the client device 20 to the server 26 via a GraphQL layer 1102. The server uses a collection of script includes 1004 to generate the requested playbook and/or workflow. The script includes 1004 are reusable server-side script logic that define a function. Script includes 1004 execute their script logic when called by other scripts.

As shown, the “script includes” 1104 may include a generate skeleton text script include 1106, a generate skeleton image script include 1008, a hydrate activities script include 1110, a hydrate trigger script include 1112, and a callback handler script include 1114, which may be configured to utilize (e.g., asynchronously) one or more capabilities 1116 to interface with one or more LLMs 306 to generate the playbook and/or workflow. For example, the generate skeleton text script include 1106 may utilize a generate process text 1004 capability to interface with an LLM 306 to generate text representing a skeleton workflow based on the request for the playbook and/or workflow. Similarly, the generate skeleton image script include 1008 may utilize a generate process image 1002 capability to interface with an LLM 306 to generate an image of the skeleton workflow (e.g., as shown in FIGS. 7 and 8). As previously described, the skeleton workflow is populated with placeholder activities that do not have fully defined sets of properties.

After the skeleton workflow has been generated, the hydrate activities script include 1110 may search a database 104 (e.g., using RAG or other AI-based search techniques 1034) to identify one or more candidate activities for replacing a placeholder activity, a set of placeholder activities, and/or all of the placeholder activities. The hydrate activities script include 1110 then interfaces with the hydrate activity 1006 capability to pass a prompt to the LLM 306 that identifies the candidate activities, the request to generate the playbook and/or workflow, and/or one or more characteristics of the playbook and/or workflow, and asks the LLM 306 to select an activity to replace one or more placeholder activities.

In some embodiments, a trigger may also be hydrated for the playbook and/or workflow. In such embodiments, the hydrate trigger script include 1112 searches the database 104 for one or more candidate triggers. Searching may or may not include RAG and/or other AI-base searching techniques 1034. The hydrate trigger script include 1112 then interfaces with the hydrate trigger 1026 capability to pass a prompt to the LLM 306 that identifies the candidate triggers, the request to generate the playbook and/or workflow, and/or one or more characteristics of the playbook and/or workflow, and asks the LLM 306 to select a trigger for the playbook and/or workflow.

As the server 26 works to build the playbook and/or workflow, the callback handler script include 1114 interfaces with the other script includes 1004 and capabilities 1116 to monitor the server's 26 process in generating the requested playbook and/or workflow and updates an internal transient generation context record 1118, which may be a single record or a table of records associated with generation of the playbook and/or workflow, an example of which is shown in FIG. 12. An asynchronous message bus (AMB) record watcher 1120 regularly checks the generation context record 1118 (e.g., on some schedule, in response to changes in the generation context record 1118, or on command) and provides updates (e.g., via the GraphQL layer 1102) to the client device 20 regarding the status/progress of generation of the playbook and/or workflow. In some embodiments, the generation context record 1118 may also be written to a database 104, which may be accessible by the client device 20. Further, JSON data may be provided to the client device 20 from the generation context record 1118, which may be used to generate GUIs to be displayed by the client device 20, such as the GUIs shown in FIGS. 5-10 for viewing and editing the workflow. Along these lines, the client device may provide commands, such as to cancel generating of the playbook and/or workflow, to replace placeholder activities with fully defined activities, to modify and/or define one or more characteristics of one or more activities, to replace fully defined activities with other fully defined activities, to add/remove activities, and so forth.

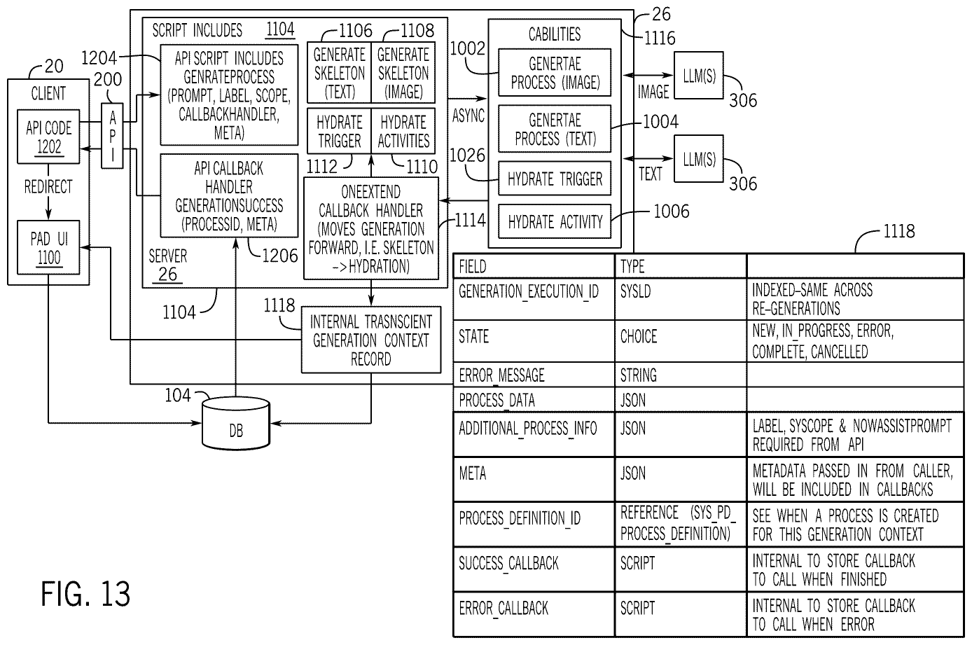

In some embodiments, the client device 20 may interface with the server 26 via an API such that requests to generate playbooks and/or workflows can be made in other applications (e.g., applications provided by an enterprise different from the enterprise that generates the playbooks and/or workflows via the server 26. Further, the API allows generated playbooks and/or workflows to be viewed and edited in other applications. Accordingly, FIG. 13 illustrates a schematic of the client device 20 interfacing with the server 26 for generating a playbook and/or workflow via an API 1200. As shown, the client device 20 runs a set of API code 1202 that enables the client device 20 to interface with the server 26 via the API 1200, thus allowing customers to build their own (or third party) playbook and/or workflow generation tools, rather than the workflow generation tools provided by the enterprise that operates the server 26 and performs the generation of the playbook and/or workflow. Accordingly, the request to generate the playbook and/or workflow is provided from the client device 20 to the server 26 via the API 1200. One or more API script includes 1204 process the request and utilize the other script includes 1104 and capabilities 1116 as described with regard to FIG. 12 to generate the playbook and/or workflow by generating a skeleton workflow, populating the workflow with fully defined activities, and populating a trigger for the workflow, if applicable. As previously described, during generation of the playbook and/or workflow, the generation context record 1118 may be generated and updated to reflect progress in generating the playbook and/or workflow. As previously described, the generation context record 1118 may be written to a database 104. As shown in FIG. 13, an API callback handler 1206 may retrieve the generation context record 1118 from the database 104 and provide updates to the client device 20 via the API 1200 that may be utilized to render updates regarding the generation of the playbook and/or workflow on a display of the client device. As such, use of the API 1200 enables enterprises to use customized or third-party tools to generate, view, and edit playbooks and/or workflows.

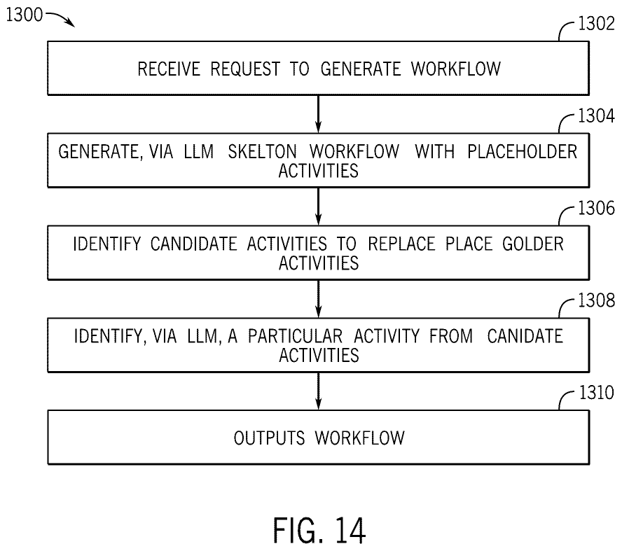

FIG. 14 is a flow chart of a process 1300 for generating a workflow. At block 1302, the process 1300 receives a natural language request to generate a playbook and/or workflow. The playbook and/or workflow may represent any process carried out in the operation of an enterprise or organization. For example, the workflow may be related to product development, credit card fraud investigation, employee onboarding, employee training, accounting, financial close, employee reviews, product testing, invoicing/billing, quality control, IT security, purchasing, inventory, logistics, employee benefit management, software development, supply chain management, vendor onboarding, and so forth.

At 1304, the process 1300 uses one or more LLMs to generate a skeleton workflow populated with placeholder activities, which may or may not be grouped into stages, based on the received request. The process 1300 may use the one or more LLMs to build the skeleton workflow placeholder-activity-by-placeholder-activity. Each placeholder activity may include proposed placeholder values for one or more properties of the corresponding placeholder activity. For example, placeholder activities may include proposed placeholder values for inputs, outputs, actions that take place to generate the outputs based on the inputs, a label, a description, rules to apply during performance of the activity, triggers that initiate the activity, advanced properties of the activity, or any combination thereof.

The LLMs may be trained on existing workflows (e.g., within the enterprise, across an industry, across multiple industries, etc.), business process model and notation (BPMN) conventions, industry standard operating procedures, industry best practices, publicly available information, publications, data from the Internet, and so forth. In some embodiments, the one or more LLMs may be “off the shelf” or “out of the box” LLMs provided by a service provider and not unique to the client instance. However, in other embodiments, the LLMs may be customized to the client instance, either with specific training, specific customized settings, or both.

At 1306, the process 1300 identifies fully defined candidate activities to replace the placeholder activities. This may include, for example, using RAG and/or other AI-based search techniques to identify one or more candidate activities from source of available activities, such as an activity library, an activity table, activities used by the instance, and so forth to replace the placeholder activities. In some embodiments, if the number of candidate activities exceeds a threshold value, the process 1300 may filter the candidate activities to reduce the number of candidate activities to a number below the threshold.

At 1308, the process provides the list of candidate activities to an LLM and asks the LLM to select one of the candidate activities to replace a placeholder activity in the playbook and/or workflow. The process 1300 may include in the prompt information about the playbook and/or workflow being generated, information from the request to generate the playbook and/or workflow, and/or other contextual data. The process 1300 receives an output from the LLM and replaces the placeholder activity with the selected activity. Using the combination of RAG and/or other AI-based search techniques with the LLM to populate the playbook and/or workflow with activities means that playbooks and/or workflows do not have to be manually populated using human inputs. This results in lower processor utilization and reduced computational costs associated with less time spent designing workflows, as well as reduced problems from human error. Further, by using RAG and/or other AI-based search techniques, and in some embodiments, filtering, to reduce the number of candidate activities being sent to the LLM, payloads to the LLM are smaller and the LLM spends less time identifying a replacement activity because the LLM only considers the candidate activities and not all of the available activities. This results in less time, money, and computational resources used by the LLM.

Blocks 1306 and 1308 may be performed for one placeholder activity at a time, a batch of placeholder activities, or all of the placeholder activities in a playbook and/or workflow at one time. At block 1310, the process 1300 outputs the playbook and/or workflow such that all of the identified fully defined replacement activities replace placeholder activities. If no replacement fully-defined activity can be found for a placeholder activity, either because no candidates were found in block 1306, or because the LLM declined to choose an activity from a group of candidate activities, the workflow may be output with one or more placeholder activities intact.

The presently disclosed techniques are directed to a workflow generation tool that builds workflows, and in some cases entire playbooks (e.g., complete workflows along with GUIs presented as the workflow is performed), based on natural language inputs provided via the workflow generation tool, using a large language model (LLM). Specifically, a natural language input identifying one or more characteristics of a workflow to be generated may be provided via the workflow generation tool. The workflow generation tool utilizes an LLM to generate a skeleton workflow, including multiple placeholder activities. The LLM may reference existing workflows (e.g., used by the instance that hosts the workflow generation tool, within the enterprise, across an industry, across multiple industries, etc.), business process model and notation (BPMN) conventions, industry standard operating procedures, industry best practices, publicly available information, publications, data from the Internet, and so forth. The LLM builds the skeleton workflow placeholder activity by placeholder activity.

The workflow generation tool then populates the skeleton workflow by replacing the placeholder activities with fully defined activities from a library of activities (e.g., activities used by the instance that hosts the workflow generation tool, activities used by the enterprise, etc.). Specifically, the workflow generation tool uses retrieval augmented generation (RAG), or other artificial intelligence (AI)-based search techniques, and filtering to identify a group of candidate activities from the library of available activities to replace each placeholder activity. The workflow generation tool provides a prompt to the LLM identifying the group of candidate activities and requesting that the LLM select a particular activity from the candidate activities. The workflow generation tool receives, from the LLM, an identification of the particular activity and replaces the placeholder activity with the particular activity. The workflow generation tool repeats the population process for each placeholder activity in the skeleton workflow. In some cases, if the workflow generation tool cannot identify an activity to replace a placeholder activity, the workflow generation tool may keep the placeholder activity in the workflow to be defined later (e.g., based on inputs received from a client device in a workflow editing mode).

In some embodiments, the workflow generation tool may also be configured to populate a trigger of the workflow (e.g., the event or condition that initiates performance of the workflow). As with populating activities, the workflow generation tool may use RAG, or other AI-based search techniques, and filtering to identify a group of candidate triggers for the workflow. The workflow generation tool provides a prompt to the LLM identifying the group of candidate triggers and requesting that the LLM select a trigger from the candidate triggers. The workflow generation tool receives, from the LLM, an identification of the selected trigger and adds the trigger to the workflow. The workflow generation tool may populate the trigger for a workflow prior to populating the activities, after populating the activities, or in parallel with populating the activities.

As the workflow generation tool populates the activities and/or trigger for a workflow, the workflow generation tool maintains a track generation context record, which is a JSON record that tracks what steps have been performed in generating the workflow and the current status of the workflow generation. The workflow generation tool may reference the track generation context record to determine, for example, what steps have been performed so far in the workflow generation, what steps are next in the workflow generation, and so forth. Further, the workflow generation tool may be configured to generate a graphical user interface (GUI) that may be displayed on the client device during workflow generation. Accordingly, the workflow generation tool may reference the track generation context record and update the GUI to reflect the progress/status of the workflow generation. The workflow generation tool may also be accessible via API, allowing users to develop their own custom workflow generation GUIs that provide inputs to, and retrieve data from, the workflow generation tool via the API and update based on the retrieved data.

Use of the disclosed techniques may include lower processor utilization and reduced computational costs associated with less time spent designing workflows. Further, deployment of the presently disclosed techniques may reduce problems with workflows resulting from human error.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a natural language request to generate a workflow, wherein the natural language request specifies a characteristic of the workflow;
generating, using a large language model (LLM), a skeleton workflow based on the characteristic, wherein the skeleton workflow comprises first and second placeholder activities;
identifying, via retrieval augmented generation (RAG), a plurality of candidate activities, from a library of activities, to replace the first placeholder activity;
identifying, using the LLM, a particular activity from the plurality of candidate activities to replace the first placeholder activity; and
outputting the workflow, based on the skeleton workflow, that includes the particular activity in place of the first placeholder activity.

2. The method of claim 1, comprising:
identifying, via RAG, a plurality candidate triggers for the workflow, from a library of triggers; and
identifying, using the LLM, a particular trigger from the plurality of candidate triggers;
wherein the workflow is configured to be initiated based on the particular trigger.

3. The method of claim 1, comprising maintaining a track generation context record during the generation of the workflow, wherein the track generation context record indicates:
one or more steps that have been performed during the generation of the workflow; and
a current status of the generation of the workflow.

4. The method of claim 3, wherein the track generation context record comprises a JSON object.

5. The method of claim 3, comprising determining a next step in the generation of the workflow based on the track generation context record.

6. The method of claim 3, comprising:
generating an update to a graphical user interface (GUI) based on the track generation context record; and
providing the update to a client device, causing the client device to update the GUI on a display.

7. The method of claim 1, comprising filtering the plurality of candidate activities to reduce a number of candidate activities in the plurality of candidate activities prior to identifying the particular activity from the plurality of candidate activities to replace the first placeholder activity.

8. The method of claim 1, wherein the natural language request to generate the workflow is received via an application programming interface (API).

9. The method of claim 1, comprising:
identifying, via RAG, an additional plurality of candidate activities, from the library of activities, to replace the second placeholder activity; and
identifying, using the LLM, an additional particular activity from the additional plurality of candidate activities to replace the second placeholder activity; and
wherein the workflow includes the additional particular activity in place of the second placeholder activity.

10. The method of claim 1, comprising identifying, via RAG, that there are no candidate activities in the library of activities to replace the second placeholder activity, wherein the workflow includes the second placeholder activity.

11. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
receiving a natural language request to generate a workflow, wherein the natural language request specifies a characteristic of the workflow;
generating, using a large language model (LLM), a skeleton workflow based on the characteristic, wherein the skeleton workflow comprises first and second placeholder activities;
identifying, via retrieval augmented generation (RAG), a plurality of candidate activities, from a library of activities, to replace the first placeholder activity;
identifying, using the LLM, a particular activity from the plurality of candidate activities to replace the first placeholder activity; and
outputting the workflow, based on the skeleton workflow, that includes the particular activity in place of the first placeholder activity.

12. The system of claim 11, wherein the operations comprise:
identifying, via RAG, a plurality candidate triggers for the workflow, from a library of triggers; and
identifying, using the LLM, a particular trigger from the plurality of candidate triggers;
wherein the workflow is configured to be initiated based on the particular trigger.

13. The system of claim 11, wherein the operations comprise maintaining a track generation context record during the generation of the workflow, wherein the track generation context record indicates:
one or more steps that have been performed during the generation of the workflow; and
a current status of the generation of the workflow.

14. The system of claim 13, wherein the operations comprise determining a next step in the generation of the workflow based on the track generation context record.

15. The system of claim 13, wherein the operations comprise:
generating an update to a graphical user interface (GUI) based on the track generation context record; and
providing the update to a client device, causing the client device to update the GUI on a display.

16. The system of claim 11, wherein the operations comprise identifying, via RAG, that there are no candidate activities in the library of activities to replace the second placeholder activity, wherein the workflow includes the second placeholder activity.

17. A non-transitory, computer readable medium comprising instructions that, when executed by processing circuitry, cause the processing circuitry to perform operations comprising:
receiving a natural language request to generate a workflow, wherein the natural language request specifies a characteristic of the workflow;
generating, using a large language model (LLM), a skeleton workflow based on the characteristic, wherein the skeleton workflow comprises first and second placeholder activities;
identifying, via retrieval augmented generation (RAG), a plurality of candidate activities, from a library of activities, to replace the first placeholder activity;
identifying, using the LLM, a particular activity from the plurality of candidate activities to replace the first placeholder activity; and
outputting the workflow, based on the skeleton workflow, that includes the particular activity in place of the first placeholder activity.

18. The non-transitory, computer readable medium of claim 17, wherein the operations comprise maintaining a track generation context record during the generation of the workflow, wherein the track generation context record indicates:
one or more steps that have been performed during the generation of the workflow; and
a current status of the generation of the workflow.

19. The non-transitory, computer readable medium of claim 18, wherein the operations comprise determining a next step in the generation of the workflow based on the track generation context record.

20. The non-transitory, computer readable medium of claim 18, wherein the operations comprise:
generating an update to a graphical user interface (GUI) based on the track generation context record; and
providing the update to a client device, causing the client device to update the GUI on a display.
